(19) United States
(12) Patent Application Publication
(10) Pub. No.: US 2009/0112854 A1
(43) Pub. Date: Apr. 30, 2009

(54) SYSTEM AND METHOD FOR RELATED INFORMATION SEARCH AND PRESENTATION FROM USER INTERFACE CONTENT

(76) Inventor: ROBERT A. WHITE, Needham, MA (US)

Correspondence Address: HOLLAND & KNIGHT LLP, 10 ST. JAMES AVENUE, 11th Floor, BOSTON, MA, 02116-3889, US

(21) Appl. No.: 12/239,067

(22) Filed: Sep. 26, 2008

Related U.S. Application Data
(63) Continuation-in-part of application No. 11/680,645, filed on Mar. 1, 2007.
(60) Provisional application No. 60/882,048, filed on Dec. 27, 2006.

(51) Int. Cl. G06F 7/06; G06F 17/30

(52) U.S. Cl. 707/5; 707/E17.108

(57) ABSTRACT

A method and computer program product for extracting primary information from the content in response to a user selecting indicia rendered on a display of the handheld device. The primary information includes entities mentioned within the content. Related information is obtained from one or more content sources based on the primary information. The content is annotated to link at least a portion of the content to at least a portion of the related information, thus defining annotated content.

### CROSS-REFERENCE TO RELATED APPLICATIONS

This application is a continuation-in-part of U.S. patent application Ser. No. 11/680,645, filed on 1 Mar. 2007, and entitled SYSTEM AND METHOD FOR RELATED INFORMATION SEARCH AND PRESENTATION FROM USER INTERFACE CONTENT; which claimed the priority of U.S. provisional patent application Ser. No. 60/882,048, filed 27 Dec. 2006, and entitled SYSTEM AND METHOD FOR RELATED INFORMATION SEARCH AND PRESENTATION FROM USER INTERFACE CONTENT. The entire disclosures of the above-identified applications are herein incorporated by reference.

### TECHNICAL FIELD

This disclosure relates to data retrieval and, more particularly, to the automated retrieval of data to supplement a webpage.

### BACKGROUND

The Internet is a wonderful tool that allows people to obtain information concerning countless topics from a variety of sources. Through the use of the Internet, a person may research various topics and obtain information concerning the research topic. Unfortunately, one of the downsides of the Internet is what makes it so valuable . . . namely the vastness of the Internet. Accordingly, the ability to separate the useful data from the useless data is of paramount importance.

Further, controlling the level of detail at which the data is presented is important, as the user may sometimes want a quick overview of a story, while other times may want a more detailed analysis. Accordingly, in situations in which an overview of a story is provided, the user may wish to be able to quickly gather more information concerning the specifics of the story.

### SUMMARY OF DISCLOSURE

In a first implementation, a method of processing content presented within a first page rendered on a handheld device includes extracting primary information from the content in response to a user selecting indicia rendered on a display of the handheld device. The primary information includes entities mentioned within the content. Related information is obtained from one or more content sources based on the primary information. The content is annotated to link at least a portion of the content to at least a portion of the related information, thus defining annotated content.

One or more of the following features may be included. At least a portion of the annotated content may be provided to the user in a supplemental page. At least a portion of the annotated content may be provided to the user in the first page.

Annotating the content to link at least a portion of the content to at least a portion of the related information may include associating a hyperlink with at least a portion of the content. The hyperlink may locate at least a portion of the related information.

The related information may be rendered within a related information webpage. The related information may include connection paths between the user and the entities.

The indicia selected by the user may be an onscreen icon. The annotated content may be formatted to be displayable on the display of the handheld device. Obtaining the related information from one or more content sources may include searching the one or more content sources for the related information. The one or more content sources may include one or more of: the internet, an intranet, and a database.

In another implementation, a computer program product resides on a computer readable medium that has a plurality of instructions stored on it. When executed by a processor, the instructions cause the processor to perform operations including extracting primary information from content presented within a first page rendered on a handheld device in response to a user selecting indicia rendered on a display of the handheld device. The primary information includes entities mentioned within the content. Related information is obtained from one or more content sources based on the primary information. The content is annotated to link at least a portion of the content to at least a portion of the related information, thus defining annotated content.

One or more of the following features may be included. At least a portion of the annotated content may be provided to the user in a supplemental page. At least a portion of the annotated content may be provided to the user in the first page.

Annotating the content to link at least a portion of the content to at least a portion of the related information may include associating a hyperlink with at least a portion of the content. The hyperlink may locate at least a portion of the related information.

The related information may be rendered within a related information webpage. The related information may include connection paths between the user and the entities.

The indicia selected by the user may be an onscreen icon. The annotated content may be formatted to be displayable on the display of the handheld device. Obtaining the related information from one or more content sources may include searching the one or more content sources for the related information. The one or more content sources may include one or more of: the internet, an intranet, and a database.

The details of one or more implementations are set forth in the accompanying drawings and the description below. Other features and advantages will become apparent from the description, the drawings, and the claims.

### BRIEF DESCRIPTION OF THE DRAWINGS

The drawing figures depict preferred embodiments by way of example, not by way of limitation. In the figures, like reference numerals refer to the same or similar elements.

FIG. 1A is a block diagram showing an embodiment of a system that can be used for processing a Web page and returning related information, in accordance with aspects of the present invention.

FIG. 1B is a method of generating and presenting a summary page from an original Web page, in accordance with aspects of the present invention.

FIG. 2A is an embodiment of a processing method performed between a client and a server that can be implemented by the devices of FIG. 1A, in accordance with the method of FIG. 1B.

FIG. 2B is an embodiment of a browser window layout in accordance with aspects of the present invention.

FIG. 3A is an embodiment of a browser window having a mechanism for launching summary page generation functionality in accordance with aspects of the present invention.

FIG. 3B is an embodiment of a registration screen that can be used by a user to register with the system of FIG. 1, as an example.

FIG. 3C is an embodiment of a screen summary page displayed in a second window, generated from the screen of FIG. 3A.

FIGS. 4-7A are embodiments of summary pages that can be generated from different types of Web sites and content sources.

FIG. 7B is an embodiment of a screen that can be generated by “drilling-down” on a link in a summary page.

FIG. 8A is an embodiment of a browser window having a mechanism for launching summary page generation functionality in accordance with aspects of the present invention.

FIG. 8B is an embodiment of a browser window that includes annotated content.

FIG. 8C is an embodiment of a browser window that includes at least one hyperlink that locates related information.

FIG. 8D is an embodiment of a browser window that can be generated by “drilling-down” on the hyperlink of FIG. 8C.

FIG. 8E is an embodiment of a browser window that includes at least one hyperlink that locates related information.

FIG. 8F is an embodiment of a browser window that can be generated by “drilling-down” on the hyperlink of FIG. 8E.

FIG. 8G is an embodiment of a browser window that can be generated by “drilling-down” on the hyperlink of FIG. 8E.

FIG. 8H is an embodiment of a browser window that can be generated by “drilling-down” on the hyperlink of FIG. 8E.

FIG. 8I is an embodiment of a browser window that includes at least one hyperlink that locates related information.

FIG. 8J is an embodiment of a browser window that can be generated by “drilling-down” on the hyperlink of FIG. 8I.

FIG. 8K is an embodiment of a browser window that can be generated by “drilling-down” on the hyperlink of FIG. 8I.

FIG. 8L is an embodiment of a browser window that can be generated by “drilling-down” on the hyperlink of FIG. 8I.

FIG. 9 is a diagrammatic view of a handheld device rendering a display screen generated by the system of FIG. 1.

### DETAILED DESCRIPTION OF THE PREFERRED EMBODIMENTS

It will be understood that, although the terms first, second, etc. may be used herein to describe various elements, these elements should not be limited by these terms. These terms are used to distinguish one element from another, but not to imply a required sequence of elements. For example, a first element may be termed a second element, and, similarly, a second element may be termed a first element, without departing from the scope of the present invention. As used herein, the term “and/or” includes any and all combinations of one or more of the associated listed items.

It will be understood that when an element is referred to as being “on” or “connected” or “coupled” to another element, it may be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a” “an” and “the” are intended to include the plural forms as well, unless the context clearly indicates otherwise. It will be further understood that the terms “comprises”, “comprising”, “includes” and/or “including”, when used herein, specify the presence of stated features, steps, operations, elements, and/or components, but do not preclude the presence or addition of one or more other features, steps, operations, elements, components, and/or groups thereof.

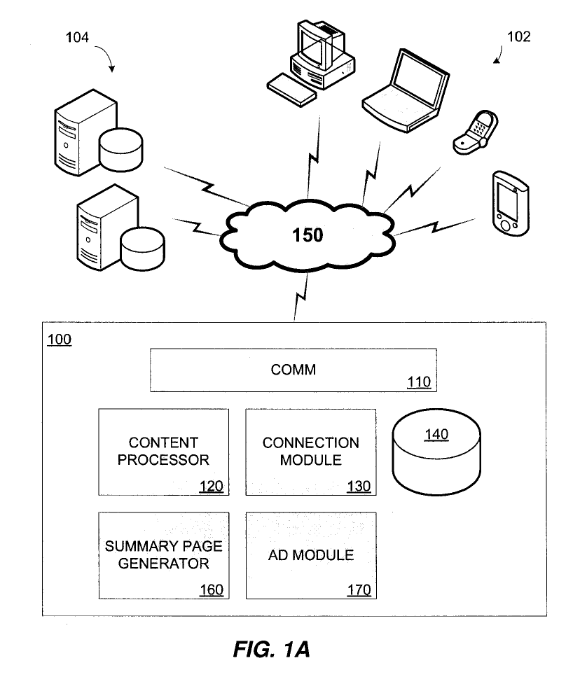

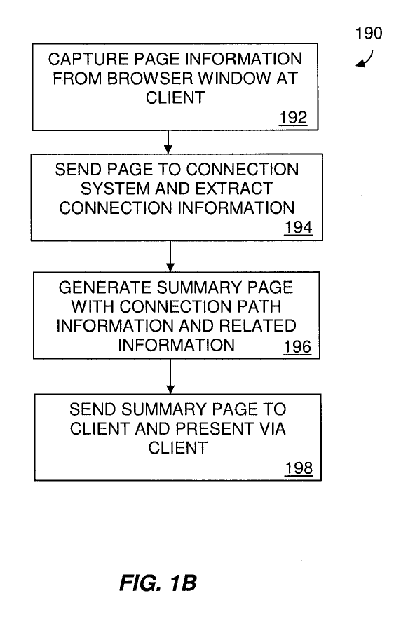

FIG. 1A is a block diagram showing an embodiment of a system and application modules 100 (collectively, the “generation system 100” or “system 100”), useful for analyzing content of a page displayed in a browser window to generate a summary page that includes information related to the original content, as related information. The related information may include information about the entities mentioned in the original content and information showing connection paths (or connections) from a user to those entities. System 100 may be used for processing a Web page (or the like) presented on any of a variety of user devices 102 and returning the related information. In this embodiment, the system 100 may be accessed by a variety of types of user devices 102 via one or more networks, collectively depicted as a network or network cloud 150.

The instruction sets and subroutines of the above-described application modules, which may be stored on a storage device (not shown) included within system 100, may be executed by one or more processors (not shown) and one or more memory architectures (not shown) incorporated into system 100. Examples of the storage device may include but is not limited to: a hard disk drive; a tape drive; an optical drive; a RAID array; a random access memory (RAM); and a read-only memory (ROM).

Network 150 may comprise one or more of the Internet, World Wide Web, a local area network, wide area network, virtual network, cellular network, satellite network, cable network, and so on, whether wired, wireless, or some combination thereof. User devices 102 may include one or more of a personal computer (e.g., desktop or laptop computer), cellular telephone, personal digital assistant, or other network enabled device.

In this exemplary embodiment, system 100 may comprise a database 140 of information that includes information used to form connection paths between people and entities (e.g., companies). A connection path (or connections) is, generally speaking, a relationship between two entities (e.g., people). One entity may define a starting point or node in the connection path and the other entity may define an ending point or node, referred to as a target, in the connection path. There may be intermediate connection points or nodes between the starting and the ending points that form part of the connection path. Each point or node is defined by electronic information available from one or more databases or systems, such as database 140. As will be appreciated by those skilled in the art, database 140 may comprise any type or combination of databases systems and/or storage media, such as one or more of a hard drive, optical drive, disk, tape, RAM, ROM, and so forth.

A set of functional modules are included to interact with user devices 102, database 140, and, if necessary, third party databases, content sources, and/or service providers 104 (collectively, “third party systems”). The functional modules of system 100 may include a communications module 110 configured to interact with the user devices 102 and third party systems 104 via network 150, using known communication hardware, software and protocols.

As an example, the user devices 102 may be configured with a client-side program that captures a Web page from a browser window and communicates it to system 100 via network 150, and further processes or assists in processing information received from system 100 via network 150.

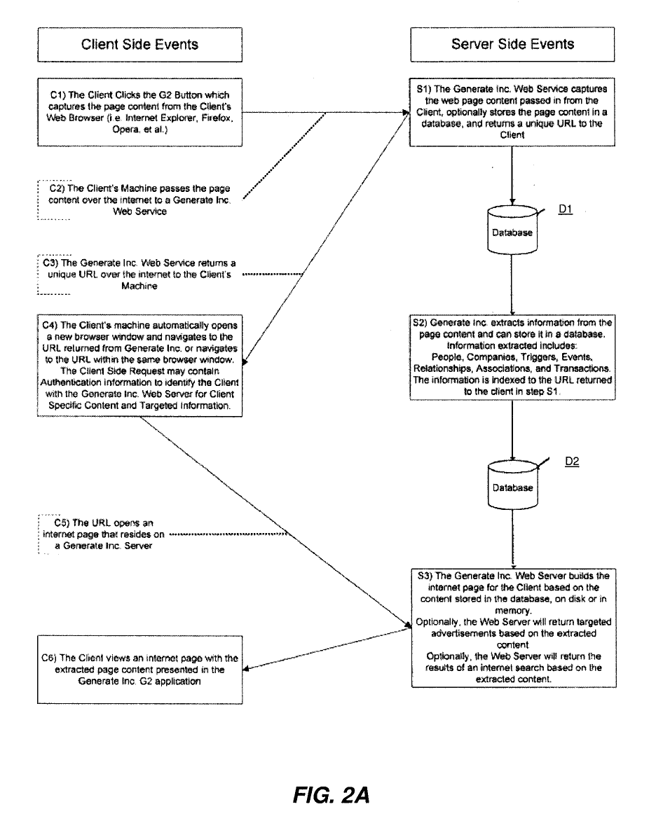

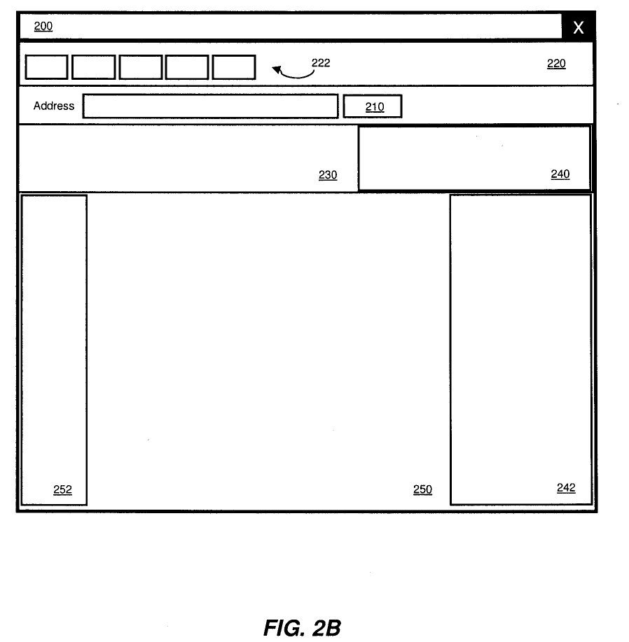

System 100 may include a content processor module 120 configured to extract information from, for example, a Web page being viewed by a user (not shown) operating a user device 102, and referred to generally as content or original Web page content. The information extracted from the content is referred to as primary information and includes, in this embodiment, people, entities (e.g., companies) and events mentioned in the content, e.g., an article being viewed in a browser. Given that a browser window may include a plurality of segments (or panes) within which information may be presented, the content processor module 120 may further be configured to determine at least one specific segment from which the primary information is to be extracted, see for example FIG. 2B. Such determination may be made based on HTML tags of a Web page, for example.

System 100 also includes a connection module 130 that finds information related to the primary information from database 140 and, optionally, third party systems 104. The related information may include connections between the user and the people and entities included in the primary information and/or information otherwise available that references or is related to the primary information.

System 100 further includes a summary page generator 160 configured to generate a summary page having items of primary information and related information, which may include selectable active links.

System 100 may optionally include an advertising (or ad) module 170 configured to serve ads based on one or more of the primary information, related information, and/or the user.

It should be understood, that while the illustrative embodiment indicates that system 100 performs Internet and Web searching and returns the summary page, client side software could be configured to accomplish some of that same functionality, e.g., in conjunction with system 100. It should also be understood that system 100 could be a standalone system, or it could be part of an enterprise system of a company or other entity. It should also be understood, that a combination of client, enterprise and standalone functionality could be used to provide the functions disclosed herein.

FIG. 1B provides a flowchart depicting a method 190 for generating a summary page having connection path information from a Web page, in accordance with aspects of the present invention. As a first step, upon activation of the appropriate mechanism (e.g., a toolbar button, see button 210 in FIG. 2B) a program is launched that captures Web page information from the page displayed in the browser window. In step 194, the captured page information is sent to system 100, where connection information is extracted from the page, such as names of people and companies mentioned in the original content. In step 196 a summary page is generated that includes connections from a user to the people and/or companies extracted. In step 198 the summary page is sent to the client device for presentation.

FIG. 2A is an embodiment of a processing method that may be implemented between a client-side device or system (i.e., user device 102) and a server-side device or system (i.e., system 100) to accomplish the above described functions. The method of FIG. 2A is one possible detailed embodiment of the method of FIG. 1B. In this embodiment, an interactive mechanism, such as a button, is included in the browser of the user device, wherein the client-side functionality is associated with the button, and launched upon actuation of the button. However, this is for illustrative purposes only and is not intended to be a limitation of this disclosure as other configurations are possible and are considered to be within the scope of this disclosure. For example, the interactive mechanism may merely be the loading of the subject web page. Specifically, upon the user selecting a webpage for viewing, the functionality of method 190 may be implemented.

FIG. 2B provides an embodiment of a browser window 200 having a button 210 configured to launch the client-side functionality. The window 200 also has a toolbar 220 that includes other typical browser buttons 222 known in the art, such as those used for navigating among Web pages, refreshing a Web page, and returning to a home page. The page displayed in window 200 may include header information in a segment 230 used to identify the Web site. The page 200 may also include various segments for ads, such as segment 240 and 242. The primary content is provided in segment 250, and page navigation tabs or menus may be provided in segment 252, as sidebar content.

Returning to FIG. 2A, in step C1, on the client side, a user clicks the button 210 associated or integral with the browser window 200 of the user device 102 (as a first window), which launches the client-side functionality to initiate dynamic Web page analysis of the page displayed in the first window 200. The dynamic Web page analysis inspects the Web page, e.g., inspect the Web page HTML, to extract or capture some or all of the content of a Web page displayed in the browser window 200. If the Web browser window 200 includes a plurality of segments within which information is presented, this step may further comprise determining at least one specific segment from which the primary information is to be extracted, such as segment 250. For example, information in advertising segments 240 and 242 may be ignored.

In step C2, the client device 102 transfers the captured page information to the server system 100, via network 150.

In step S1, on the server side, the captured page information may optionally be stored in a database D1, which may form part of database 140 in FIG. 1A. The content processor 120 of system 100 may be configured to generate and return a unique URL to the client device 102, also indicated by step C3 on the client-side device.

In step S2, on the server side, the content processor 120 extracts primary information from the captured page information, which may be stored in a database D2. Database D2 may also form part of database 140 of FIG. 1A. In this embodiment, the extracted primary information includes information identifying people, entities (e.g., companies) and events captured from the original Web page content in segment 250 of Web page 200. The extracted information may also include triggers, relationships, associations, and transactions captured from the original Web page. The information is indexed to the URL sent to the client device 102.

In accordance with the illustrative embodiment, a trigger is an event that indicates that a prospect or customer, in a sales context, might be receptive to a call. In this context, the idea is to identify the customers (or other people) at the earliest point in the buying cycle. System 100 may be used to scan thousands of news articles, blogs, market reports, etc. per day trying to identify these events. This number could be scaled up or down in various embodiments. These events may include management changes, new investments, lawsuits, site openings and others. For example, if a company leases out commercial space it will most likely need phone systems, office furniture, insurance, etc. The trigger may let a sales person know that a new lease has been signed.

In steps C4 and C5, on the client side, the user device 102 opens a second browser window and navigates to the URL in the second window. The client side issues a request to system 100 for a summary page at the URL, which is presented in the second browser window. Alternatively, the summary page may be presented in the first browser window, and no second window need be opened. In either case, the summary page includes items of primary information and items of related information.

The request from the user device 102 may include user authentication information to identify the client and/or user with server system 100, e.g., for obtaining user specific content and targeted information.

In step S3, on the server side, the summary page generator 160 builds the summary page as a Web page. Information for generating the summary page may be obtained from or based on the information stored in the database 140 from step D2, which may include the primary information extracted from the original Web page and the related information obtained in relation to the primary information. The system 100 may also include items of information obtained from third party systems 104, e.g., in a Web-based or Internet search.

Optionally, advertising or targeted advertising may be included in conjunction with the summary page, and served by ad module 170. For example, as discussed with respect to FIG. 1A, the system 100 may include an advertising module 170 configured to serve up advertisements based on the entities (e.g., companies), people and events mentioned in an article of the original Web page, or the information in the summary page, or information about the user.

In step C6, on the client side, the returned summary page is displayed in the second window (if one was opened), within the first window, or a combination of both. Information within the summary page is presented for viewing and interaction by a user of the user device 102. Items of primary information and items of related information may be displayed as active links that allow the user to selectively “drill down” on such items to gain further information or migrate to, for example, a different Web page, search engine, system 100, and/or another site.

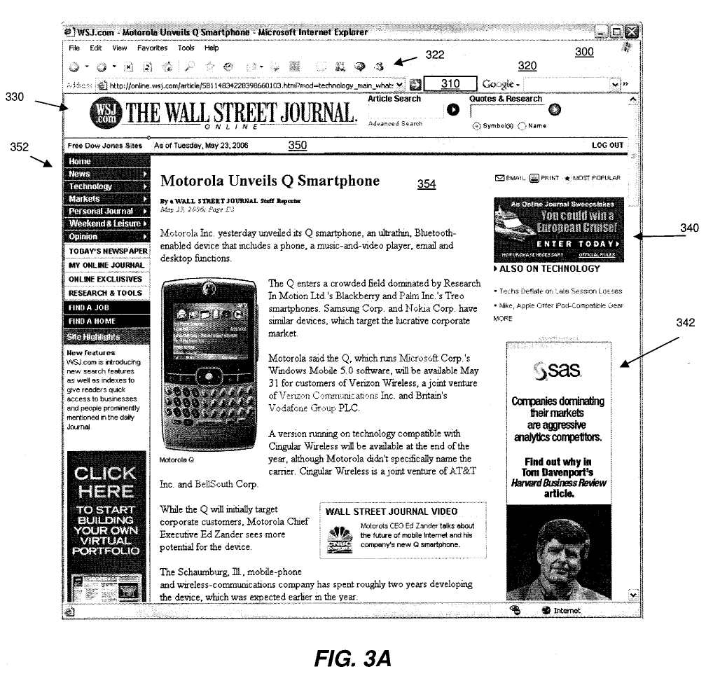

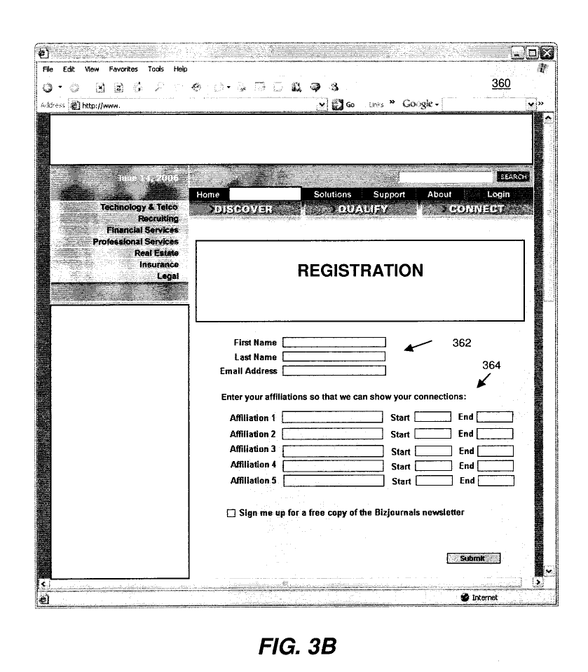

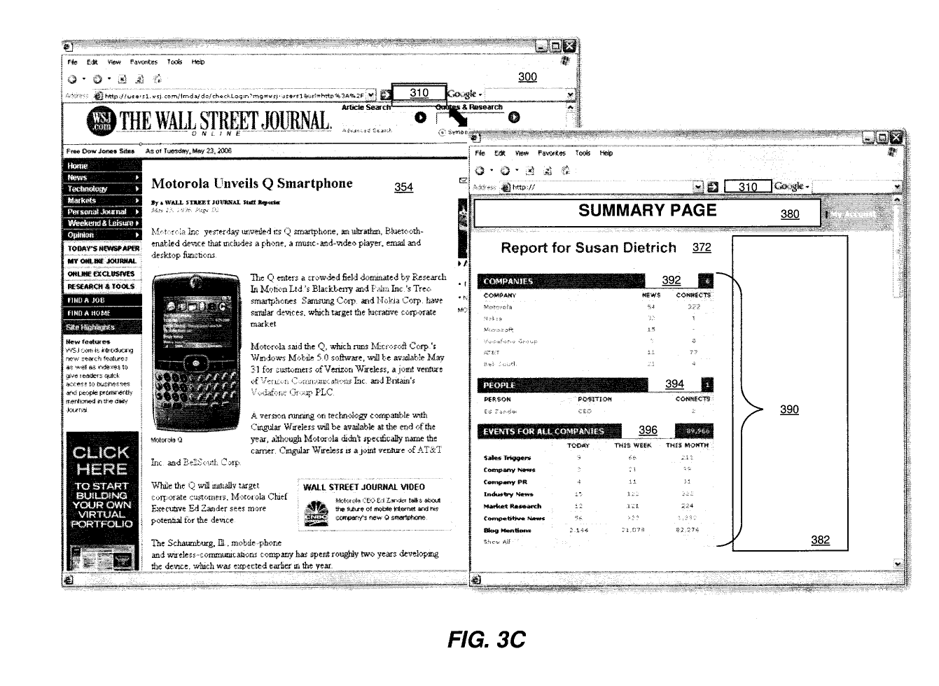

FIG. 3A shows an example of a browser window 300 that may be displayed on a user device 102. In this example, the original Web page is a Web page from the Web site of the Wall Street Journal, as indicated in header segment 330 of window 300. Advertising information is provided in segments 340 and 342 and the original Web page content 354 from which the primary information is captured is displayed in a main segment 350. A segment 352 includes sidebar content, e.g., user selectable tabs for navigation to other pages.

The browser window 300 also includes a summary page generation button 310, corresponding to button 210 in FIG. 2B, as an illustrative embodiment of an interactive mechanism that may be used to initiate summary page generation from the content of the browser window 300, including the search and aggregation of information related to the primary information from system 100 and/or other third party sources 104. Button 310 has been added to the toolbar area 320 of the browser window 300. In other embodiments, the user mechanism could additionally or alternatively be provided in other manners associated with browser 300, e.g., in a menu or as a floating icon or button.

Button 310 may be implemented as a plug-in to a typical browser program installed on a user device 102, such as Internet Explorer™ (Microsoft Corporation), Netscape Navigator™ (Netscape Communications Corporation), and the like. As an example, a user may access system 100 via the Web and download an executable program that, once executed on the user's device, installs the plug-in. This manner of downloading and installing programs is known in the art, as are application program interfaces (APIs) for a variety of browsers that enable the addition of plug-ins.

System 100 can, therefore, be configured to generate a download page that contains text describing the functionality of button 310 and instructions for downloading and installing button 310. As an example, the text description on the download page rendered by system 100 may read something like:
Use the toolbar button to analyze any Web page for information on the people, companies and events mentioned on the page. Simply click the Download Now icon to download and install the button.

The download of button 310 may be implemented as a self-extracting file that contains all of the files required for installing the toolbar button. When the user clicks the Download Now option the user may be presented with a dialog box that requests its username and password. The user may enter their credentials and click “Continue” or may click “Cancel.” After entering its user credentials a standard file Run or Save dialog box may be displayed. The user may select “Run” to download the file and automatically install button 310. The user may click “Save” to download and save the install package, and run it at a later time. The user may click “Cancel” to return to the download page.

The installation process may run automatically after download or when the user executes the downloaded file. The install process may complete without any required user interaction. And button 310 may display in the browser immediately after installation, without the user taking any other action.

In various embodiments, the download could be made available on a separate server. As a result, users could download and install the button 310 from such server, without going to system 100. For example, a company (or other entity) could make the download available via their corporate network. In other embodiments, the program for installing button 310 could be provided in any other storage media, such as by e-mail or on a CD ROM.

User credentials may be stored on the client, e.g., in a “cookie”. In such a case, the user would not have to type credentials to run the functions associated with button 310. Rather, only a single click of button 310 would be required to execute the above process. Otherwise, the user could enter its credentials for a new session with system 100. Generally, storing user credentials on the client device to expedite login or access to a remote system in known, so not disclosed in detail herein.

In some embodiments, button 310 can include a drop down menu, where a list of options can be displayed in association (e.g., below) the button. The menu may contain one or more of the following user selectable commands:
“Home Page”—Navigates to the home page of system 100.
“Options”—The options menu selection displays a dialog box that allows the user to change the credentials that the button is using or to specify parameters for how the process should be run.
“Help”—The help option displays a sub-menu that includes: a link to a help page on the system 100. The help page can describe the toolbar and its use.
“Uninstall”—Selecting uninstall prompts the user with a dialog that reads “Uninstall will remove the toolbar and all associated files.” The user can click Continue or Cancel.
“About Toolbar”—The about option displays a dialog box with the version number of the toolbar.

The options dialog may contain, for example, username and password fields. The username may be read, the password may be displayed as non-text characters, e.g., asterisks. The user may change the username and password and save them for future use.

The options page may contain a “Forgot password” link. This link may navigate the user to system 100 to allow the user to request a new password or to get hints relating to the existing passwords.

The options page may contain a selection that specifies if the user wants system 100 to try to limit the page analysis to the main segment 350 and content of the Web page (e.g., an article, but not advertisements). This setting is titled “Limit page analysis to content only,” in the preferred embodiment.

In various embodiments, registration with system 100 may be required to use the functionality associated with button 310. This may be particularly important for establishing an identity of the user for generating connection paths between the user and other entities. In such a case, the installation of button 310 may include initiation of a registration session with system 100. Otherwise, a registration session could be initiated upon activation of button 310, e.g., at first use of button 310. FIG. 3B provides an embodiment of a registration window 360 that could be opened upon actuation of button 310. Window 360, in this embodiment, is generated by system 100 and includes a set of text entry fields 362 for user input of its name and e-mail address. A second set of fields 364 solicits input of connection information for the registering user. That is, the information input in fields 364 may be used to determine connection paths.

In such cases, system 100 may include a user account module (not shown in FIG. 1A) that accomplishes registration, authentication, and account management, and the registration information may be stored in database 140, for example. In other embodiments various types of known registration processes may be implemented. Account management may include maintaining a set of connections to and from the user and database 140, for example. After registration, the user's subsequent access could require a login to system 100. Again, identifying the user may be necessary for determining connection paths to the user. If login is required, actuation of button 310 could open a login window (not shown), rather than a registration window. Login may be required to gain access to the summary page generation functionality and information resources available through system 100. In various embodiments, after registration for example, the user's credentials could be automatically saved on the client devices and sent to system 100 using, for example, a cookie loaded on the user's device 102.

In another embodiment, the system 100 could be configured such that, rather than logging in to the system, the system (or client-side software) could access and analyze the user's contact database on user device 102 and determine connection paths therefrom—in real or near-real time. In some embodiments, the system 100 and/or user device 102 could be configured to implement both approaches. For example, registered users could be entitled to receive more connection path information than non-registered users.

In the present illustrative embodiment, selection or activation of button 310 launches certain functionality for analysis and processing of the page being viewed in the browser window 300. When a Web page includes several segments with different information, e.g., advertisements 340, 342, links to other information, sidebar content 352, and the like, the functionality may be configured to distinguish the main segment 350 and its content (e.g., an article) 354 from the other segments, and to process the content 354 from the main segment 350 and to ignore the other information in the other segments. Distinguishing among these types of segments may be done through analysis of the HTML that defines the Web page.

System 100 may be configured to maintain a list of domains and relevant tags that help to describe the article content of a Web page, apart from ancillary content of the page. This may make processing the Web page more efficient, because the user need not request such action and the analysis of the page may be immediately focused on finding the predefined tag. Bizjournals™ (American City Business Journals, Inc.), for example, could add one or more <div> tags to its article pages that would specify the relevant content to be analyzed. System 100 could be configured to analyze only the contents of the page delineated by that tag or tags.

Processing a Web page using button 310 of FIG. 3A may be better appreciated with respect to the illustrative functional modules of FIG. 1A and the window of FIG. 3C. Specifically, in the illustrative embodiment, when a user clicks or selects button 310, at least a portion of the content of the page is captured and transferred to system 100. In this example, the original content 354 is located in main segment 350 of browser window 300, and is captured and transferred to system 100. At system 100 the content processor 120 is configured to reformat the captured content into a universal document (e.g., an XML document). The universal document is processed by an extraction engine, also part of the content processor 120 in this embodiment. Content processor 120 is configured to output a structured document containing information about one or more of the people, entities (e.g., companies), and news/events within the original content 354.

An entity will often be a company, but may be any type of entity, e.g., university or college, organization, treaty members, government entity, special interest group, club, charity, society, association, or the like. An event may be a management change, product announcement, joint venture, merger, or other noteworthy topic that the extraction engine has been configured to look for within the reformatted structured version of the original Web page content. The structured document is formed to include a list of people, entities, and events mentioned in the content.

The connection module 130 includes an import routine configured to match the people and entities in the structured document to people and entities in an existing database 140, which may include contact information for such people and entities and other useful information, as related information. The connection module 130 may also be configured to search the Internet and Web and other third party systems 104 for additional related information, to update the information in database 140, or both.

The connection module 130 may be configured to determine connection paths from a user, e.g., a user identified in the Web browser session, to people (e.g., executives) and entities mentioned in the original Web page content 354. The connection paths may be, for example, based on the work history and a “power network” of the user (e.g., other people that the user knows) and a target person named in content 354, which may also be stored in the system database 140 or on the user device 102. An electronic address book from an application such as Outlook™ (Microsoft Corporation), Lotus Notes™ (Lotus Software, a subsidiary of IBM Corporation), or Palm Pilot™ (Palm, Inc.) may serve as a basis for connection path information. And a resume, a “CV,” employment related records, or publicly available content could serve as a basis for work history information.

The related information, e.g., connection path information and company information, is returned by system 100 to the client device 102 for presentation, using communication module 110. The presentation may take the form of a summary page displayed on the user device 102 in the original first window or in a new second window. For example, the summary page may take the form of a Web page generated by system 100 and returned in a new browser window on user device 102. In some embodiments, the summary page may be provided via an e-mail, e.g., in addition to or as an alternative to, presentation in a first or second browser window. In such a case, the e-mail may include a link to the summary page or the summary page itself. In such cases, the ability to copy another user on the e-mail may be provided.

If the summary page is presented in the original window, rather than generating a new second window, the summary page results may take up only a portion of the window, e.g., leaving all or some of the original content presented. Alternatively, the summary page information could take up the entire first window.

The summary page may include a list of entities, a list of people, and a list of events mentioned in the original Web page content. The list of entities and people may include a number of news stories or other relevant sites on the Worldwide Web that have been indexed for each person or entity, as related information. The lists may also include the number of connection paths from the user to the person or company (i.e. target), again as related information. The returned summary page may also include a list of the events associated with the people and entities mentioned in the original Web page content.

The summary page may be provided in a form that enables the user to “drill down” on an executive, entity, news link, connection path or other pieces of information to retrieve additional information inside the system 100, or elsewhere on the Internet and Web. That is, the items of information in the summary page may include active links to the system's database 140 or other information obtained from searching third party systems 104 on the Internet and Web. Preferably, the entire process will take only a matter of seconds, or less. The user will be able to analyze Web page content (e.g., an article) quickly and easily in real-time.

The example of FIGS. 3A and 3B is continued in FIG. 3C, which provides an example of a summary page presented in a second window 370. In this embodiment, a summary page 380 is generated in response to the selection of button 310 and returned to user device 102 by the system 100. The user is identified as “Susan Dietrich” in the subtitle “Report for Susan Dietrich” 372. Summary page 380 is generated using the original page content 354 of browser window 300, i.e. the article entitled “Motorola Unveils Q Smartphone.” The summary page 380 includes a segment 382 that may be used for presenting ads using ad module 170 of FIG. 1A.

In this example, summary page 380 includes a set of lists or tables 390 that list various entities (in this case companies), people, and events—i.e., primary information taken from the original content 354 and the related information stored at or otherwise obtained by system 100 for those people and companies included in the primary information. Specifically, the returned summary page 380 in the second window 370 includes a list of COMPANIES 392, PEOPLE 394, and EVENTS 396.

The list of COMPANIES 392 is a list of each company mentioned in article 354, e.g., Motorola, Inc., Nokia Corporation, Microsoft Corporation, Vodafone Group Plc, and so on. A column entitled “NEWS” lists the number of news stories that mention each company. For example, for Motorola, Inc. the count is 54. A column entitled “CONNECTS” lists the number of connections between the user and each company. For example, for Motorola, Inc. the number of connections is 322. The NEWS and CONNECTS information may be found in the original Web page content 354, system 100 or third party systems 104, user device 102, or a combination thereof.

The list entitled PEOPLE 394 is a list of each person mentioned in the original Web page content 354. List 394 includes a column entitled “PERSON” that provides the name of each person listed in content 354 and a column entitled “POSITION” that provides the job title of each person listed, if available. And a column entitled “CONNECTS” indicates the number of connections between the person and the user Susan Dietrich. Here, there is only one entry, Ed Zander. As shown in FIG. 3C, Ed Zander's position is CEO and there are 2 connections between Susan Dietrich and Ed Zander. The POSITION and CONNECTS information may be found in the original Web page content 354, system 100 or third party systems 104, user device 102, or a combination thereof.

The list entitled “EVENTS FOR ALL COMPANIES” 396 is a list of a number of events of a specific type aggregated for each company mentioned in original Web page content 354. In the embodiment of FIG. 3C, the event types are listed as “Sales Triggers,” “Company News,” “Company PR,” “Industry News,” “Market Research,” “Competitive News,” and “Blog Mentions.” In other embodiments, different event types could be defined. In this embodiment, the list of events 396 includes three columns, entitled “TODAY,” “THIS WEEK,” and “THIS MONTH.” For each type of event there is a count given for each time column. In other embodiments, other time designations could be made. And rather than being aggregated, a count could be shown for each company. The EVENTS FOR ALL COMPANIES 396 information may be found in the original Web page content 354, system 100 or third party systems 104, user device 102, or a combination thereof.

To generate the connection path information in the above lists, additional Web searches may be executed based on the contents 354. In other words, when user clicks button 310, the contents 354 of the browser window 300 may be analyzed and then one or more Web searches based on the information within the contents 354 may be run to gather related information. In each list, connection path information may include hot links to further information. For example, a company name may be a hot link, selection of which generates a page with information about that company.

As mentioned above, the processing may be limited to only a specific segment of the Web browser window. In this example, processing is limited to content 354 in main segments 350. That is, advertisements, links and other text that are not necessarily related to the content 354 presented in the browser, nor useful for generating a summary page and connection information are ignored. The page presented in browser window 300 is parsed based on tags within the HTML of the page, and only the content 354 is processed through the content processor 120 (and its extraction engine) of system 100.

In ad segment 382, ads may be presented based on the entities (e.g., companies), people, and events mentioned in the original Web page content 354. For example, if the user is reading an article or product announcement in the browser window on a new cell phone, then the ad module 170 of system 100 may be configured to serve up an ad for the Motorola Q™ phone.

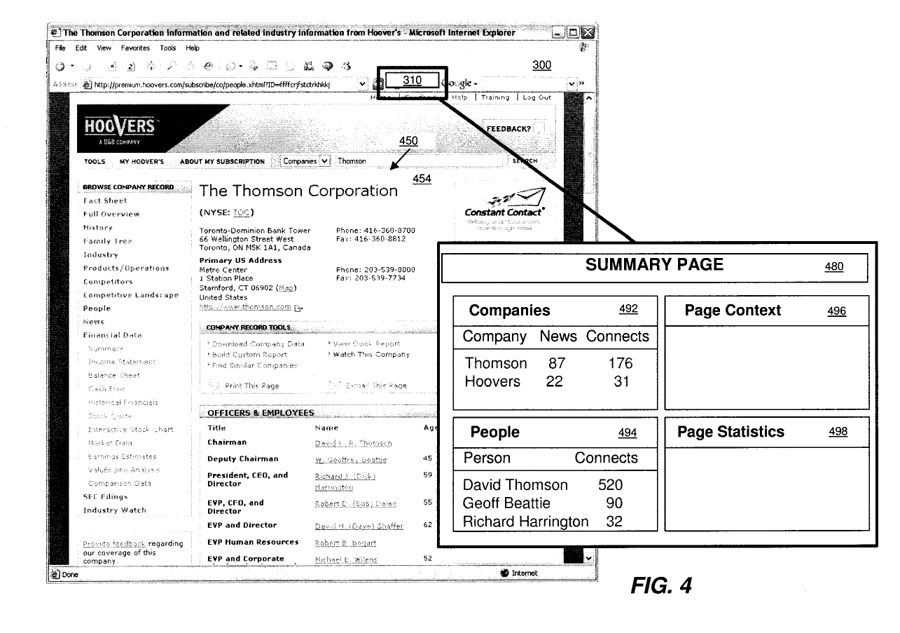

FIGS. 4-7 depict exemplary embodiments of various summary pages that may be generated from a browser window using button 310. As described above, the summary page may be presented in any of a variety of manners, e.g., in a first or second window.

FIG. 4 shows browser window 300 opened up to the Web site of Hoover's, Inc., which has a main segment 450 within which there is displayed a company record for The Thompson Corporation, as original content 454. Actuation of button 310 causes processing of content 454 to generate a summary page 480, in a manner similar to that described above with respect to summary page 380 of FIG. 3C.

The summary page 480 takes a format similar of that of summary page 380. As with summary page 380, summary page 480 includes a list of Companies 492 and that includes a column for the name of each Company mentioned in content 454. There is also a column for News and a column for Connects, similar to those described above. Summary page 480 also includes a list for People 494, which includes a column for the name of each person mentioned in the content 454, also as described above. Optionally, summary page 480 may include a portion entitled Page Context 496 that describes the context in which the events in the summary page occurred, such as a business context, e.g., merger, buyout and so on. The summary page 480 may optionally include a portion entitled Page Statistics 498 that displays information relating to the Web hosting environment, such as statistics about the page itself, e.g., page word count and an identification of the server hosting the Web page.

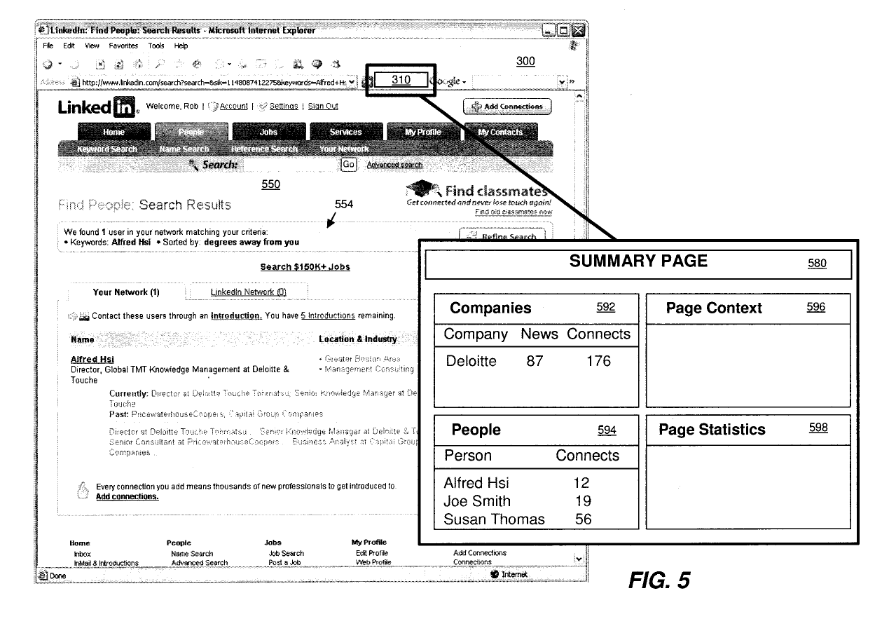

FIG. 5 shows browser window 300 opened to the Web site of LinkedIn Corporation, which has a main segment 550 within which there is displayed a search result, as original content 554. Actuation of button 310 causes processing of content 554 to generate a summary page 580, in a manner similar to that described above with respect to summary page 380 of FIG. 3C. The summary page 580 takes a format similar of that of summary page 480. As with summary page 480, summary page 580 includes lists for Companies 592, People, 594, Page Content 596, and Page Statistics 598.

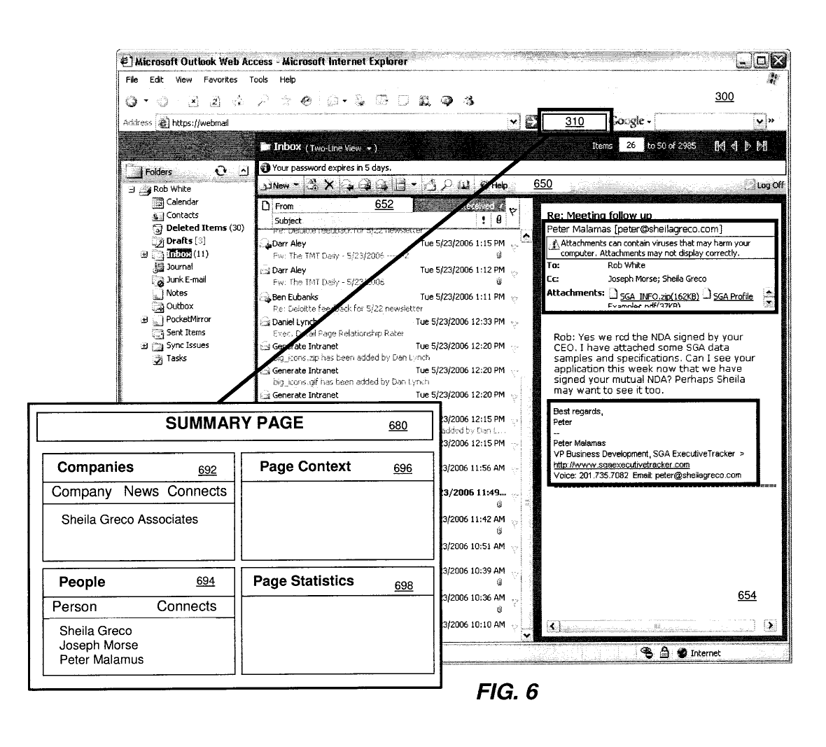

FIG. 6 shows browser window 300 opened to an Outlook™ (Microsoft Corporation) Web-mail interface, which has a main segment 650 within which there is displayed a list of e-mails 652 and a viewing segment or pane with the text of a selected e-mail, as original content 654. Actuation of button 310 causes processing of content 654 to generate a summary page 680, in the manner described above with respect to summary page 380 of FIG. 3C. The summary page 680 takes a format similar of that of summary page 480. As with summary page 480, summary page 680 includes lists for Companies 692, People, 694, Page Content 696, and Page Statistics 698.

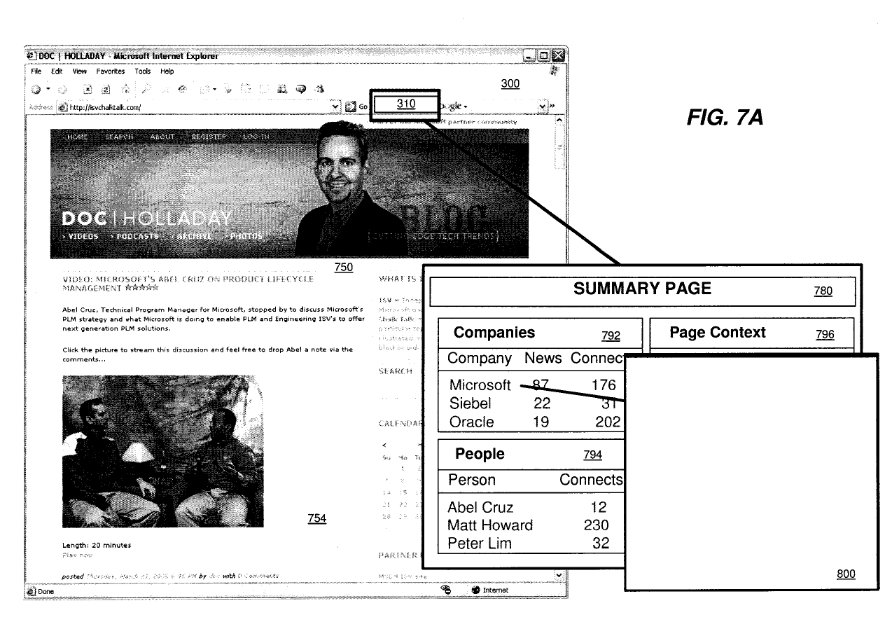

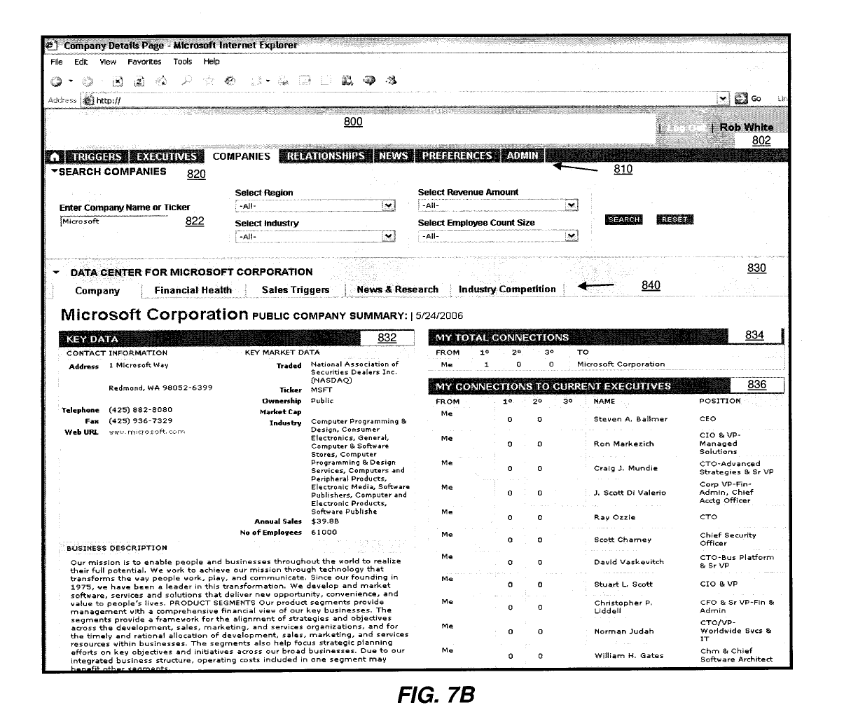

FIG. 7A shows browser window 300 opened to a blog Web site for Doc Holladay, by Microsoft Corporation, which has a main segment 750 within which there is displayed video and text relating to an interview with Microsoft's Abel Cruz, as original content 754. Actuation of button 310 causes processing of content 754 to generate a summary page 780, in a manner similar to that described above with respect to summary page 380 of FIG. 3C. The summary page 780 takes a format similar of that of summary page 480. As with summary page 480, summary page 780 includes lists for Companies 792, People, 794, Page Content 796, and Page Statistics 798 (not shown).

FIGS. 7A and 7B also demonstrate the ability to drill down on information presented in a summary page, here summary page 780. In this example, the companies' names in list 792 are active links to more detailed company and connection information. When, for example, the name Microsoft is selected, window 800 is generated for the presentation of such information.

FIG. 7B demonstrates representative content for window 800 when “Microsoft” is selected. Note that the information is presented relative to a logged in user, Rob White 802. In this example, the screen is presented with a set of tabs 810 that allow viewing of different types of information about the selected company. The tabs 810 include Triggers, Executives, Companies, Relationships, News, Preferences, and Admin. In FIG. 7B, the Companies tab is selected, which includes a set of fields 820 for user input of search criteria. The company name Microsoft (for Microsoft Corporation) is defaulted into the Enter Company Name or Ticker field 822, as the screen was generated by selecting Microsoft from the summary screen 780.

Screen 800 also includes a data portion 830, entitled DATA CENTER FOR MICROSOFT CORPORATION, which presents company information and connection information. Data portion 830 also includes a set of tabs 840, entitled Company, Financial Health, Sales Triggers, News & Research, and Industry Competition. Selection of a tab causes data portion 830 to render information related to the subject indicated by the tab label. A section entitled KEY DATA 832 includes general corporate and investor information about Microsoft Corporation. A section entitled MY TOTAL CONNECTIONS 834 provides a list of connections the user 802 has to Microsoft and the degrees of the connection. The degree indicates the number of nodes or connects to a target person (inclusive of the target person). Here 1^{st}, 2^{nd}, and 3^{rd} degrees are accommodated. A section of data portion 830 entitled MY CONNECTION TO CURRENT EXECUTIVES 834 provides a list of the user's connections to those executives, and lists each executive and his or her title.

Screens similar to screen 800 may preferably be generated from any summary screen, when such related information is available on an entity listed in the summary page. Summary page 800 is merely one example.

In various embodiments, a content provider Web site, such as www.wsj.com (by the Wall Street Journal) or www.bizjournals.com (by BizJournals), may be configured to provide users with an option of downloading button 310, e.g., as a feature of the content provider Web site. Toolbar button 310 may be installed in a toolbar of the Web browser of the user as a branded button that drives traffic to the content provider's Web page from any Web site. For example, the user could be reading a Wall St. Journal article, their favorite blog, or be looking at a company profile in Hoovers. In each case the toolbar button 310 acts as an extension to the current Web page allowing the user to distill the information in the Web page into a clear summary page overview. The user finds itself in a new browser window where the content provider's brand and advertising may be displayed. Advertising may also be displayed in the new window in relation to the content of the page the user is processing. Because button 310 extracts the people, companies, and events from the Web page, the publisher of the original Web page may serve advertising that is related to the page. In other cases the button may be provided as a co-branded toolbar button of the content provider and a company providing the functionality of the button 310.

As an additional service, the publisher may register the user and provide user credentials. When the user is logged into system 100, this will provide personalization within the Web browser that shows connection paths from the user to the extracted people and companies. Enabling these connection paths requires system 100 to have access to the user's company and executive affiliations. The user could be provided with an interface to enable the user to enter this information, e.g., a Web page served by system 100. Preferably, the interface provides an intuitive mechanism for helping the user to add these affiliations.

The branded toolbar button may differentiate the content provider's Web site offering from other news, research, and list services. The toolbar button provides real-time information and does not require the user to navigate to an information application and login, and takes the next step from simply locating content. Search engines, like Google™, Yahoo™, etc., provide useful ways to locate content, but button 310 and system 100 take the next step to distilling and making sense of it.

As discussed above, system 100 may include a summary page generator 160 configured to generate a summary page having items of primary information and related information, which may include selectable active links. However, while the summary page is described above as being a separate and distinct page that is formatted in a fashion dissimilar to that of the original webpage from which the summary page was generated, this is for illustrative purposes only and is not intended to be a limitation of this disclosure, as other configurations are considered to be within the scope of this disclosure. For example, summary page generator 160 may be configured to generate a summary page that is formatted similarly (if not identically) to that of the webpage from which the summary page was generated. Additionally, the summary page need not be a separate page with respect to the webpage from which the summary page was generated. Accordingly, summary page generator 160 may be configured to overwrite the original webpage with the newly-generated summary page. Summary page generator 160 may be configured to annotate the content (e.g., content 354, FIG. 3A) included within the original webpage (included within browser window 300, FIG. 3A) to link at least a portion of the content (e.g., content 354) to at least a portion of the related information.

Specifically, system 100 may be configured to process content 354 to extract primary information from content 354 in response to an action taken by a user (not shown). As discussed above, the primary information may include entities (e.g., names, places, companies, events) mentioned within the content. Related information may be obtained from one or more content sources (e.g., database 140, third party databases, content sources, and/or service providers 104) based upon the primary information. Summary page generator 160 may then annotate content 354 to link at least a portion of content 354 to at least a portion of the related information and provide at least a portion of the annotated content to the user.

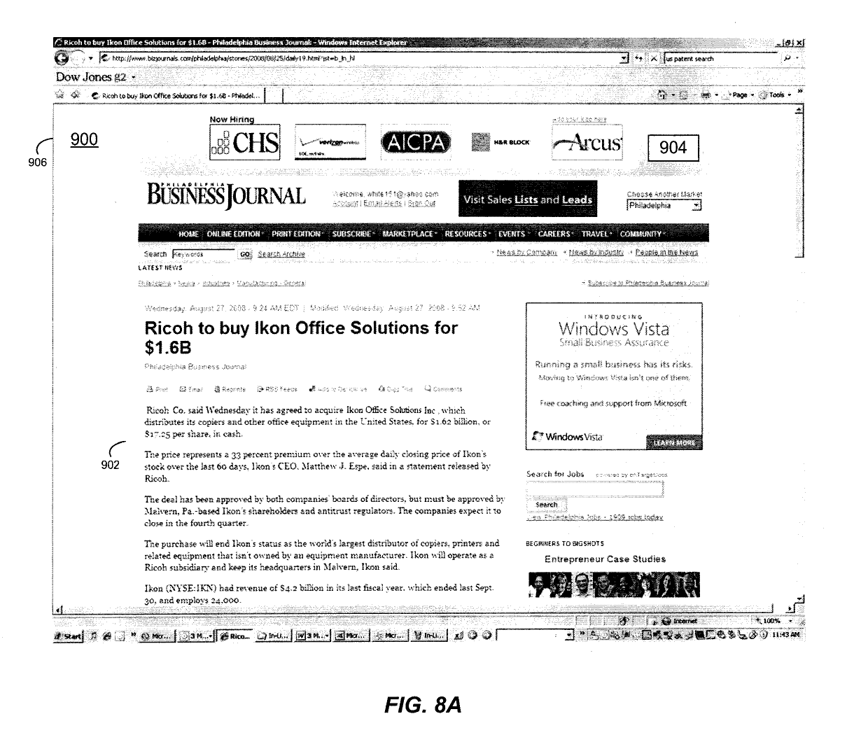

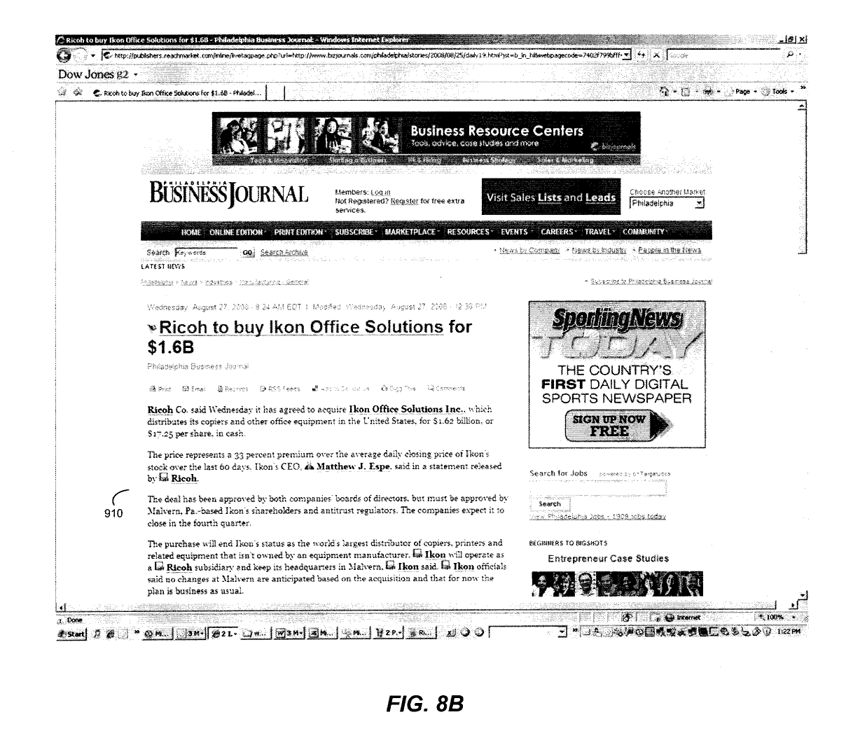

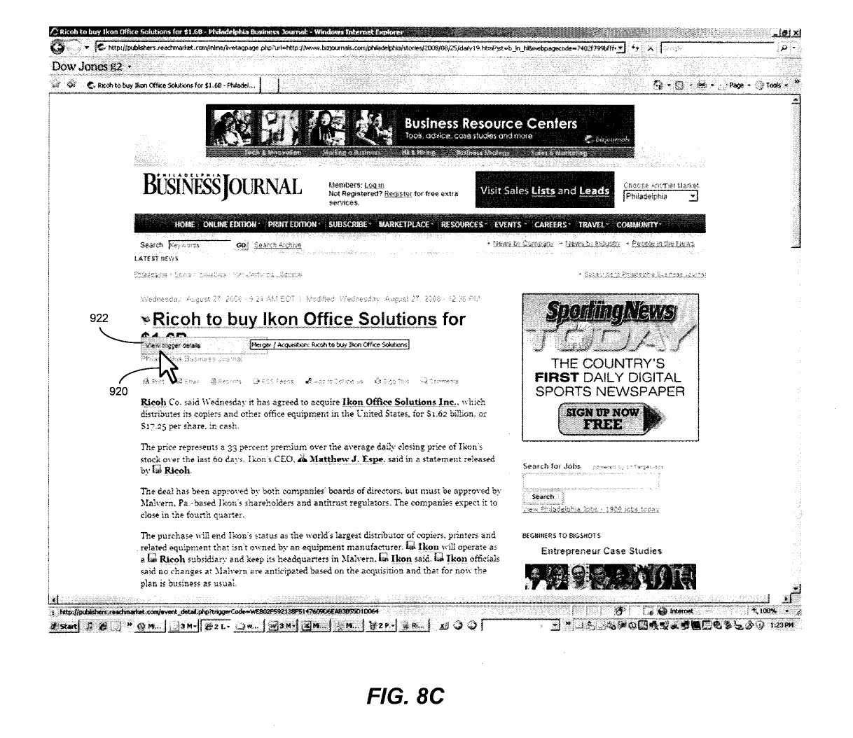

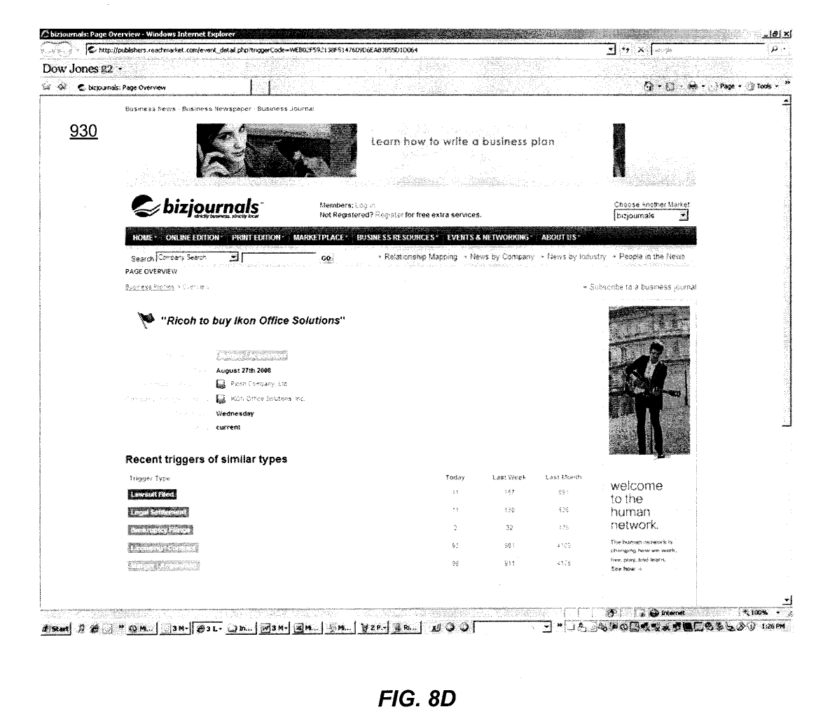

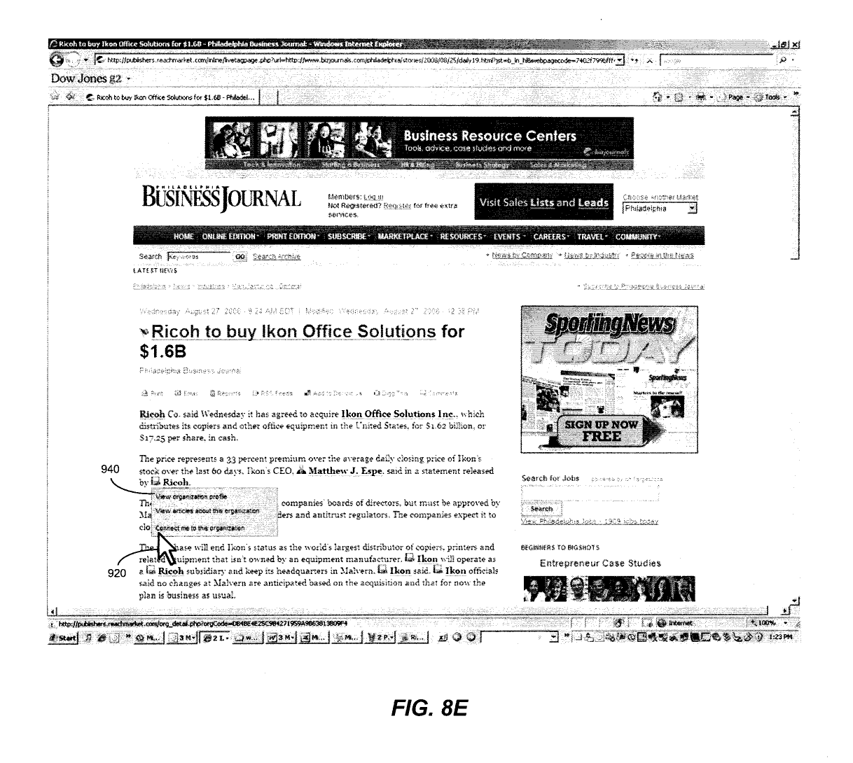

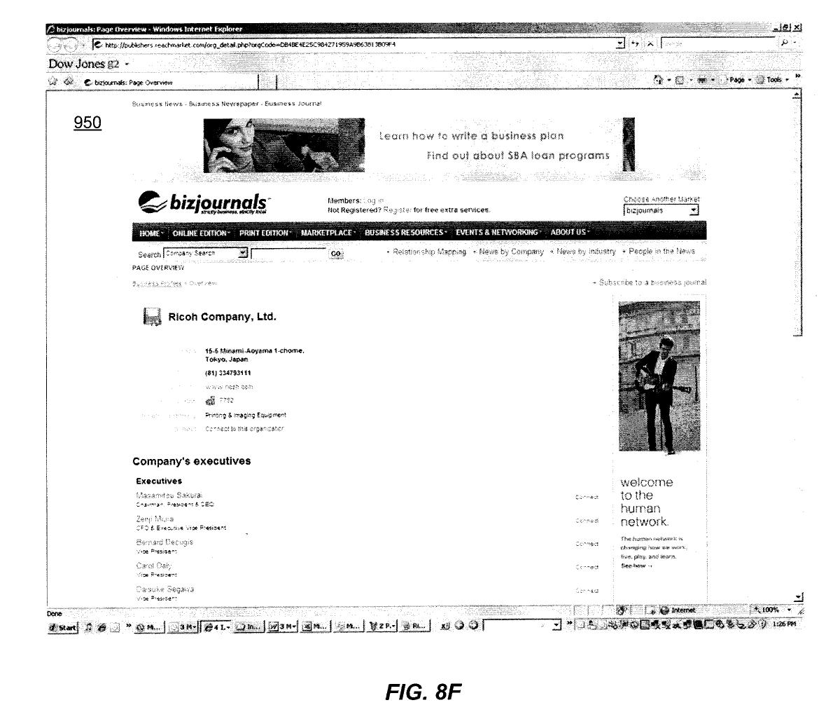

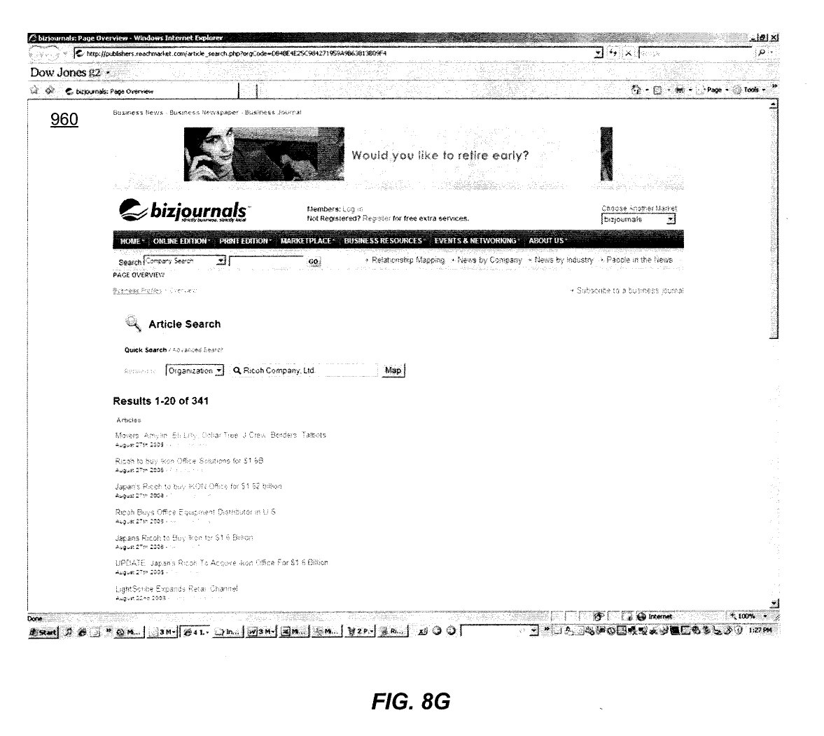

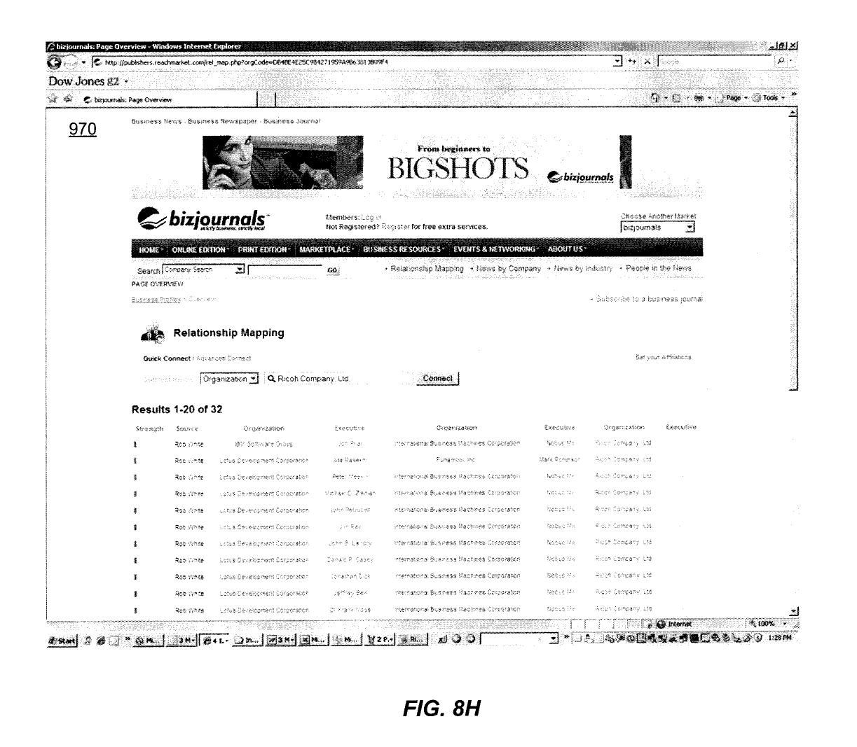

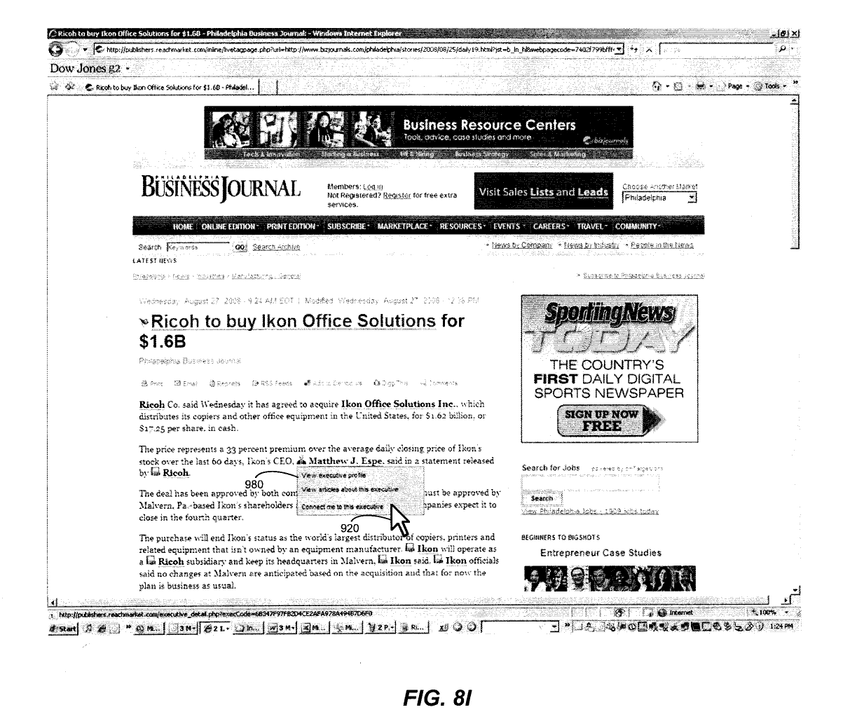

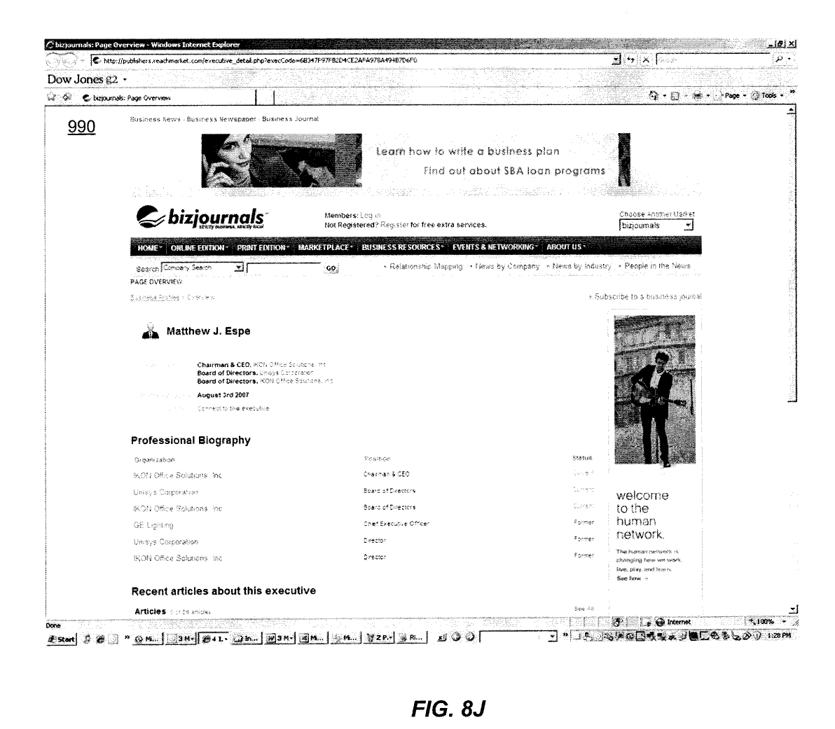

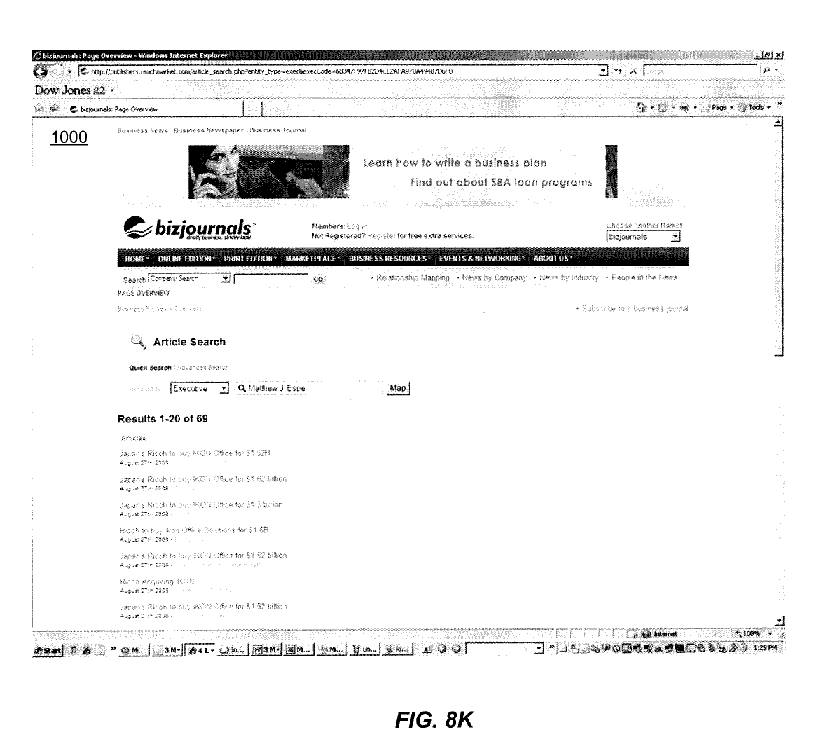

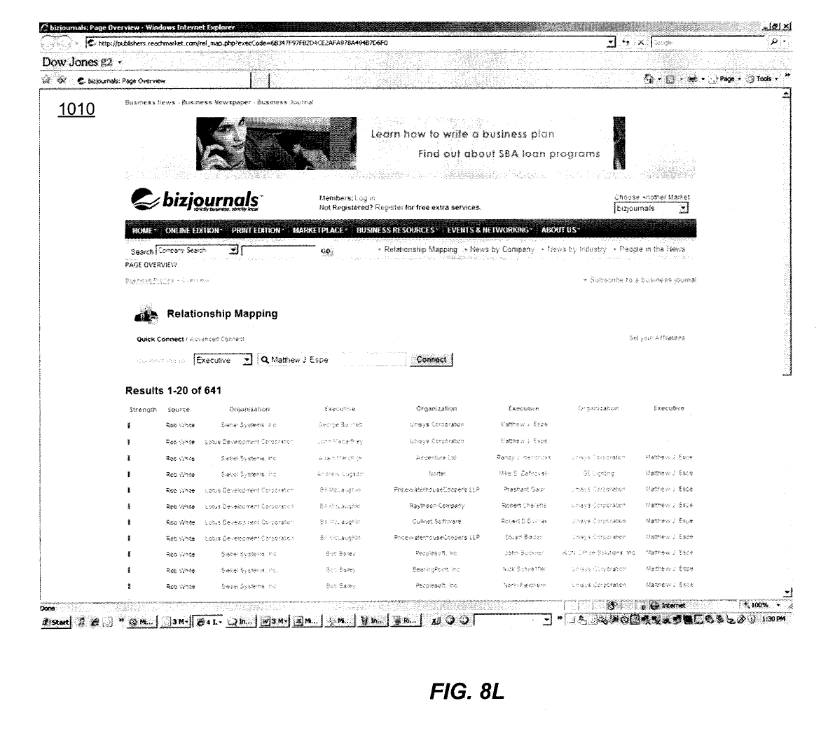

For example and referring also to FIG. 8A, assume that a user is browsing webpage 900 and wishes to obtain some additional information concerning the entities defined within content 902. In this illustrative embodiment, when the user selects button 904, at least a portion of content 902 of webpage 900 may be captured and transferred to system 100. At system 100, content processor 120 may be configured to reformat the captured content (e.g., content 902) into a universal document (e.g., an XML document). The universal document may be processed by an extraction engine (e.g., included within content processor 120) to extract primary information from the captured content. Content processor 120 may be configured to output a structured document containing information about one or more of the people, entities, and news/events (i.e., the primary information) within content 902. In this particular example, the primary information may include Ricoh Company, Ltd. and Matthew J. Espe.

While system 100 is described above as initiating the processing of content 902 based upon the user selecting button 904, this is for illustrative purposes only and is not intended to be a limitation of this disclosure, as other configurations are possible. For example, system 100 may be configured to initiate the processing of content 902 upon the user viewing content 902 within window 906.

As discussed above, connection module 130 may include an import routine configured to match the people and entities (i.e., primary information) defined within the structured document to people and entities in an existing database 140, which may include contact information for such people and entities and other useful information, as related information. Connection module 130 may also be configured to search the Internet and Web and other third party systems 104 for additional related information, to update the information in database 140, or both.

Further and as discussed above, connection module 130 may be configured to determine connection paths from a user, e.g., a user identified in the Web browser session, to people (e.g., executives) and entities mentioned in captured content 902. The connection paths may be, for example, based on the work history and a “power network” of the user (e.g., other people that the user knows) and a target person named in captured content 902, which may also be stored in the system database 140 or on the user device 102.

Communication module 110 of system 100 may provide the above-described related information to client device 102 for presentation. In this particular example, the presentation may take the form of an annotated version of the captured content 902 included within the original webpage (included within browser window 906). The annotated version of captured content 902 may link at least a portion of captured content 902 to at least a portion of the related information obtained from e.g., database 140, third party databases, content sources, and/or service providers 104.

Referring also to FIG. 8B, there is shown an illustrative example of annotated content 910 (i.e., an annotated version of captured content 902). In this particular example, various portions of the content (e.g., “Ricoh”, “Ikon Office Solutions Inc.”, “Matthew J. Espe” and “Ricoh to buy Ikon Office Solutions”) are shown as bold text. When generating annotated content, system 100 may associate a hyperlink with at least a portion of the content (e.g., “Ricoh”, “Ikon Office Solutions Inc.”, “Matthew J. Espe”, and “Ricoh to buy Ikon Office Solutions”). These hyperlinks may be configured to locate at least a portion of the appropriate related information. For example, system 100 may associate a hyperlink with “Ricoh” that locates related information concerning Ricoh. Further, system 100 may associate a hyperlink with “Ikon Office Solutions Inc.” that locates related information concerning Ikon Office Solutions. Additionally, system 100 may associate a hyperlink with “Matthew J. Espe” that locates related information concerning Matthew J. Espe. Further still, system 100 may associate a hyperlink with “Ricoh to buy Ikon Office Solutions” that locates related information concerning Ricoh buying Ikon Office Solutions.

Referring also to FIG. 8C, system 100 may be configured to allow a user to position onscreen pointer 920 (controllable via a pointing device such as a mouse; not shown) above a hyperlink (e.g., the hyperlink associated with “Ricoh to buy Ikon Office Solutions”) to generate popup window 922 that defines the specific hyperlinks associated with “Ricoh to buy Ikon Office Solutions”. In this illustrative example, only one hyperlink is included within popup window 922, namely “View Trigger Details”. In the event that the user selects the “View Trigger Details” hyperlink, triggers related information webpage 930 (See FIG. 8D) may be generated by system 100.

Referring also to FIG. 8E, upon positioning onscreen pointer 920 above the hyperlink associated with “Ricoh”, popup window 940 may be generated that defines the specific hyperlinks associated with “Ricoh”. In this illustrative example, three hyperlinks are included within popup window 940, namely “View Organization Profile”, “View Articles about this Organization”, and “Connect me to this Organization”. In the event that the user selects the “View Organization Profile” hyperlink, profile related information webpage 950 (See FIG. 8F) may be generated by system 100. In the event that the user selects the “View Articles about this Organization” hyperlink, articles related information webpage 960 (See FIG. 8G) may be generated by system 100. In the event that the user selects the “Connect me to this Organization” hyperlink, connections related information webpage 970 (See FIG. 8H) may be generated by system 100.

Referring also to FIG. 8I, upon positioning onscreen pointer 920 above the hyperlink associated with “Matthew J. Espe”, popup window 980 may be generated that defines the specific hyperlinks associated with “Matthew J. Espe”. In this illustrative example, three hyperlinks are included within popup window 980, namely “View Executive Profile”, “View Articles about this Executive”, and “Connect me to this Executive”. In the event that the user selects the “View Executive Profile” hyperlink, profile related information webpage 990 (See FIG. 8J) may be generated by system 100. In the event that the user selects the “View Articles about this Executive” hyperlink, articles related information webpage 1000 (See FIG. 8K) may be generated by system 100. In the event that the user selects the “Connect me to this Executive” hyperlink, connections related information webpage 1010 (See FIG. 8L) may be generated by system 100.

As discussed above, user devices 102 may include one or more of a personal computer (e.g., desktop or laptop computer), cellular telephone, personal digital assistant, or other network enabled device. Accordingly, in the event that user device 102 is a handheld device (e.g., a cellular telephone or a personal digital assistant), system 100 may format the above-described annotated content to be displayable on the display of the handheld device.

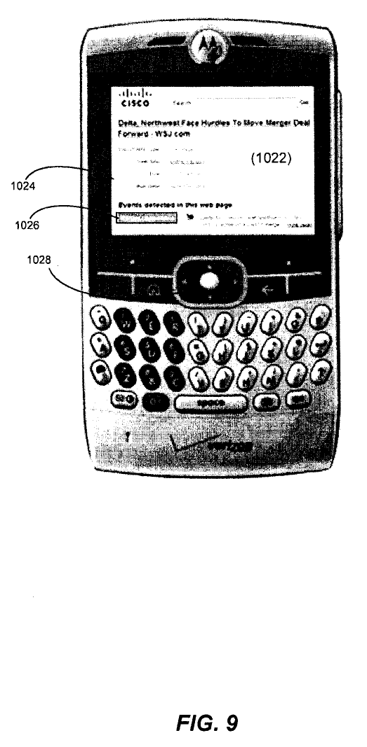

For example and referring also to FIG. 9, when system 100 is used in conjunction with handheld device 1020, any webpages (e.g., webpage 1022) rendered on handheld device 1020 may need to be formatted (e.g., sized/scaled) to fit within display 1024 of handheld device 1020. Specifically, when using a desktop computer, the display of the desktop computer may have a resolution of e.g., 1,280 pixels×1,024 pixels. However, display 1024 within handheld device 1020 may be considerably smaller and may have considerably less resolution (e.g., 320 pixels×240 pixels). Accordingly, any webpage (e.g., the original content, the annotated content, and/or the related information) rendered on display 1024 by system 100 may need to be formatted to be displayable on display 1024 of handheld device 1020.

Assume for illustrative purposes that the user is browsing webpage 1022 using handheld device 1020. System 100 may be configured to display indicia 1026 (e.g., an icon) that the user may select via pointing device 1028. Once selected, the above-described annotated content may be rendered on display 1024 of handheld device 1020. As discussed above, this annotated content may include one or more hyperlinks (that locate the above-described related information), which the user may select via pointing device 1028.

Alternatively and as discussed above, system 100 may be configured to initiate the processing of the content included within webpage 1022 upon the user viewing webpage 1022. Accordingly, webpage 1022 may be automatically processed to extract the primary information (as described above) and obtain related information based on the primary information (as described above). The content may then be automatically annotated (thus generating annotated content) and displayed on display 1024 of handheld device 1020. Accordingly, the annotated content may include indicia 1026 (e.g., an icon) that the user may select via pointing device 1028. Once selected, some or all of the above-described related information may be displayed on display 1024 of handheld device 1020.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A method of processing content presented within a first page rendered on a handheld device, the method comprising:
extracting primary information from the content in response to a user selecting indicia rendered on a display of the handheld device, the primary information including entities mentioned within the content;
obtaining related information from one or more content sources based on the primary information; and
annotating the content to link at least a portion of the content to at least a portion of the related information, thus defining annotated content.

2. The method of claim 1 further comprising:
providing at least a portion of the annotated content to the user in a supplemental page.

3. The method of claim 1 further comprising:
providing at least a portion of the annotated content to the user in the first page.

4. The method of claim 1 wherein annotating the content to link at least a portion of the content to at least a portion of the related information includes:
associating a hyperlink with at least a portion of the content, wherein the hyperlink locates at least a portion of the related information.

5. The method of claim 1 wherein the related information is rendered within a related information webpage.

6. The method of claim 1 wherein the related information includes connection paths between the user and the entities.

7. The method of claim 1 wherein the indicia selected by the user is an onscreen icon.

8. The method of claim 1 further comprising:
formatting the annotated content to be displayable on the display of the handheld device.

9. The method of claim 1 wherein obtaining the related information from one or more content sources includes:
searching the one or more content sources for the related information.

10. The method of claim 1 wherein the one or more content sources includes one or more of: the internet, an intranet, and a database.

11. A computer program product residing on a computer readable medium having a plurality of instructions stored thereon which, when executed by a processor, cause the processor to perform operations comprising:
extracting primary information from content presented within a first page rendered on a handheld device in response to a user selecting indicia rendered on a display of the handheld device, the primary information including entities mentioned within the content;
obtaining related information from one or more content sources based on the primary information; and
annotating the content to link at least a portion of the content to at least a portion of the related information, thus defining annotated content.

12. The computer program product of claim 11 further comprising instructions for:
providing at least a portion of the annotated content to the user in a supplemental page.

13. The computer program product of claim 11 further comprising instructions for:
providing at least a portion of the annotated content to the user in the first page.

14. The computer program product of claim 11 wherein the instructions for annotating the content to link at least a portion of the content to at least a portion of the related information include instructions for:
associating a hyperlink with at least a portion of the content, wherein the hyperlink locates at least a portion of the related information.

15. The computer program product of claim 11 wherein the related information is rendered within a related information webpage.

16. The computer program product of claim 11 wherein the related information includes connection paths between the user and the entities.

17. The computer program product of claim 11 wherein the indicia selected by the user is an onscreen icon.

18. The computer program product of claim 11 further comprising instructions for:
formatting the annotated content to be displayable on the display of the handheld device.

19. The computer program product of claim 11 wherein the instructions for obtaining the related information from one or more content sources include instructions for:
searching the one or more content sources for the related information.

20. The computer program product of claim 11 wherein the one or more content sources includes one or more of: the internet, an intranet, and a database.
